(19) United States
(12) Patent Application Publication
(10) Pub. No.: US 2016/0283074 A1
(43) Pub. Date: Sep. 29, 2016

(54) INFINITE RECURSION OF MONITORS IN SURVEILLANCE APPLICATIONS

(71) Applicant: Honeywell International Inc., Morristown, NJ (US)

(72) Inventors: Marine Drive, Bangalore (IN); Rajeshkumar Thappali Ramaswamy Sethuraman, Madurai (IN); Shanmugam Selvarajan, Bangalore (IN)

(21) Appl. No.: 15/081,327

(22) Filed: Mar. 25, 2016

Related U.S. Application Data
(63) Continuation of application No. 12/194,882, filed on Aug. 20, 2008, now abandoned.

(51) Int. Cl. G06F 3/0484; G06F 17/27; G06F 3/0482; H04N 7/18

(52) U.S. Cl. CPC G06F 3/0484; H04N 7/181; G06F 17/2705; G06F 3/0482

(57) ABSTRACT

Systems and methods for representing and controlling a plurality of cameras in a monitoring station are provided. Some methods can include a monitoring station receiving data streams from cameras monitoring secured areas, each of the data streams including metadata appended thereto, the metadata appended to each of the data streams identifying attributes related to a respective data stream, and a graphical user interface of the monitoring station displaying visual representations of the data streams based on a default display layout associated with each of the data streams and received user input identifying a user-defined display layout for the data streams. The user input can include an identification of a user-selected attribute and responsive thereto, a logic unit of the monitoring station can identify data streams that include metadata identifying the user-selected attribute for displaying on the graphical user interface.

### FIELD OF THE INVENTION

The present invention relates generally to surveillance systems. Specifically, the present invention relates to displaying and controlling a plurality of analog and digital video monitor layouts via a monitoring station.

### BACKGROUND OF THE INVENTION

Security and alarm systems are commonly used in secure areas to protect against intruders and other alarm events. Various conventional centralized security and alarm systems are known that provide surveillance features and options to protect the secure areas. A plurality of sensors detects abnormal conditions, and reports the conditions to a local monitoring station or to a central monitoring station. For instance, a plurality of digital Closed-Circuit Television (CCTV) cameras may monitor different areas of a secure building such as a museum and generate a data stream comprising the video feed along with other information.

The data stream generated by a sensor is typically transmitted to a control panel, whereupon it may be monitored by an operator, or reported to a monitoring station. In the CCTV example, a video stream may be transmitted to one or more monitors at a local monitoring station, with an operator reviewing the footage for irregularities. In another example, multiple video streams are streamed to a plurality of monitors arranged in a grid-like fashion. This may be termed a “monitor wall” or “display layout.” The operator views the display layout and may have the ability to configure which feed is delivered to which monitor.

With the advent of digital cameras and sensors that are able communicate across wired and wireless packet-based networks such as the Internet, there is potential for tremendous advancements in the ability to monitor and control several secure areas and security systems from a remote location. However, this functionality is not being utilized to its maximum potential.

### SUMMARY OF THE INVENTION

The present invention describes systems and methods to represent a plurality of security monitors on a control monitor. In one embodiment, the present invention is a security system comprising a plurality of sensors, a plurality of security monitors in remote locations to receive a plurality of data streams from the plurality of sensors, and a control monitor. The plurality of security monitors receives data streams from one or more of the plurality of security sensors monitoring one or more secure areas. The plurality of security monitors transmits these data streams to the control monitor. Each data stream includes tags or metadata information describing specific attributes of the data stream, such as source, feed type, priority, etc.

An operator of the control monitor is provided with an interface representing the plurality of security monitors in user-definable configurations. The operator may group the data streams or security monitors based on the attributes of the data stream, as well as other attributes defined in real-time or in the user-definable configurations. The operator further has the ability to focus on and expand one or more security monitors, and display these alongside other security monitors, all within one portion of the display on the control monitor. The operator further has the ability to control the features of the remote security monitors and security sensors, said ability to control being provided by the user interface on the control monitor. Thus, control of security systems in a plurality of remote locations is provided by a central control station.

In another embodiment, the present invention is a method for controlling the operation of a plurality of security systems, wherein a security system comprises a plurality of sensors providing data streams to a plurality of cameras to monitor a secure area, said cameras being arranged in one or more layouts, and being controlled by a local control panel. The plurality of sensors and/or the plurality of cameras provide the data streams to a centralized control station. The method further comprises tagging each data stream with a plurality of attributes such as source, date, time, priority, etc. The data streams are arranged on a user interface on a monitor that is coupled to the centralized control station. The method provides an operator with the ability to expand on any one of the plurality of security systems, and arrange the data streams in a grid-like display based on the attributes of the data stream. The operator can further define attributes to create user-defined layouts of data streams. The operator can further control features of the security systems (such as camera features and monitor features) that would typically be controlled by the local control panel.

### BRIEF DESCRIPTION OF THE DRAWINGS

FIG. 1 shows a monitoring station within a surveillance system, according to an exemplary embodiment of the present invention.

FIG. 2 shows screenshots of the recursive functionality, according to an exemplary embodiment of the present invention.

### DETAILED DESCRIPTION OF THE EMBODIMENTS

According to the present invention, a secure area may be monitored by security cameras, said security cameras providing their video or still images to one or more monitoring stations, locally or remotely. Local monitoring stations receiving the data streams may be configured in a specific layout or combination. For instance, video streams from 8 cameras may be individually fed to 8 monitors arranged in a 2×4 grid. The layout may further comprise one or more security monitor walls. The cameras themselves may further be controlled locally by an operator of the security monitors via a local control panel. Alternatively, according to an aspect of the present invention, the security cameras monitoring a secure area may further transmit their data streams to the monitoring station described herein. These data streams may be arranged in a grid-like fashion on a Graphical User Interface (GUI) on the monitoring station. Each set of data streams is arranged in a display layout, depending on the surveillance mode being used. For instance, 3×3, 4×4, 1×5 grids are different display types within a surveillance mode for one set of data streams. Another example is a single analog monitor with single view or quad view. A third example is a physical representation of a large video display wall. The GUI provides an operator with the ability to recursively represent these different monitor layout combinations. Specifically, the operator can recursively get deeper into the system and start operating on the virtual monitors. All interactive operations on the regular monitor will be supported. Features include drag/drop cameras, digital zoom, flip, correction, live Pan, Tilt, and Zoom (PTZ), alarm call-up, pre-shots, tour, and scan sequence.

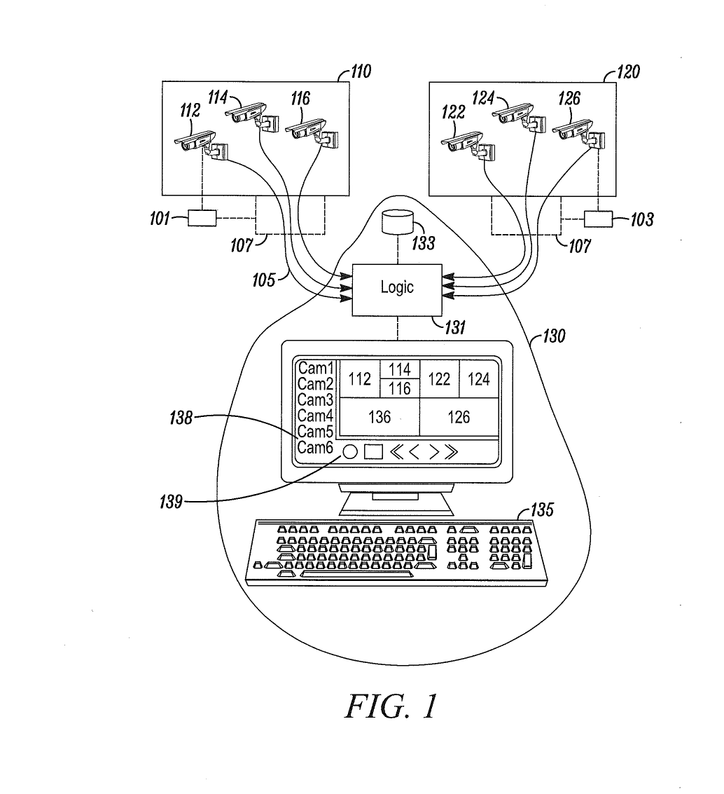

FIG. 1 shows a monitoring station within a surveillance system, according to an exemplary embodiment of the present invention. Two secure areas 110 and 120 are monitored by a plurality of sensors. In the present embodiment, cameras 112, 114, and 116 monitor secure area 110, and cameras 122, 124, and 126 monitor secure area 120. Secure areas 110 and 120 may be in the vicinity of each other, or may be remote from each other. A logic unit 101 is in communication with camera 112, and logic unit 103 is in communication with camera 126. In one embodiment, all cameras have logic units that are not shown here. The purpose of said logic units is, inter alia, to generate metadata for each data stream generated by the camera. Data streams are represented by curved lines 105.

Alternatively, logic units 101 and 103 may be in communication with a control panel, represented by dotted box 107. According to one embodiment of the present invention, the control panel 107 may receive data streams 105 from the cameras, add metadata via logic unit 101, and transmit the data streams to monitoring station 130. However, this need not be the case, and the cameras may be equipped with logic to generate metadata for a data stream and transmit the data stream to monitoring station 130, via their own transceivers (not shown). Network communication capabilities are discussed further below.

Monitoring station 130 comprises logic 131, database 133, and Graphical User Interface (GUI) 135. As can be seen in FIG. 1, GUI 135 is arranged in a grid-like fashion, with visual representations of the data streams generated by the cameras displayed in windows 136, a selection area 138, and commands 139.

According to the present embodiment, the cameras record event data and transmit the data stream to monitoring station 130. The cameras may be any type of visual recording device known in the art, including but not limited to CCTV and/or still cameras. The cameras may be equipped with transceivers to communicate over a wired or wireless network. The cameras may have motion-sensing capabilities, as well as image recognition either onboard the camera itself or as separate logic in communication with the camera, such as logic unit 103. Logic unit 103, externally or within the cameras, appends the data stream 105 with a header or metadata.

The metadata includes various attributes related to the data stream. For instance, metadata may include the following information: a) data stream configuration settings such as resolution, flames per second (for video), compression, and network settings, b) type of data stream such as network streaming feed, or composite feed via coaxial cable, c) connection details including storage paths, and d) user preferences on video display settings, layouts, display modes, etc. Metadata also include events access, privilege, and permission details for the data stream, rules and actions related with the data stream, date and time of recording, and events and alarms associated with the data stream (for instance, whether or not the data stream was recorded in response to an event or simply a normally scheduled recording, and so on). Recording in response to an event includes motion-activated recording, in which case the metadata includes that the data dream was generated in response to motion. The metadata is incorporated into the data stream in the form of a header, and is transmitted to the monitoring station 130.

Communication between elements takes place over fixed or wireless networks, such as a local, wide-area, or Internet network. For instance, cameras 112, 114 and 116 may be in communication with logic 101 (or their own respective logic units) as well as control panel 107 over a local area network, including the potential for wireless communication over wi-fi or Bluetooth. Control panel 107 would be capable of communicating over a wide-area network or ubiquitous packet-based network such as the Internet. Alternatively, cameras may be internet-capable and would communicate their data streams directly to monitoring station 130. Each camera, control panel, and monitoring station and sub-elements thereof would have their own unique address on the Internet. In one embodiment, every element is equipped with a transceiver (not shown) and has a unique Session Initiation Protocol (SIP) or Internet Protocol (IP) address.

Data streams 105 may traverse one or more network elements (not shown) before arriving at monitoring station 130. Logic 131 within monitoring station 130 recognizes incoming data streams and parses the metadata contained within the header of data streams 105. Referring to a database 133, logic 131 retrieves default display layouts or “monitor walls” for each incoming data stream. These may be listed as display options in GUI 135, for instance in the selection area 138. Alternatively, selection area 138 may display a list of cameras/sources, and an operator is able to select which source he wants displayed. An operator or an administrator of the system may create user-defined layouts that replicate the prior-art monitor walls, but are represented on one window of the grid 136.

For instance, the present embodiment shows cameras 112, 114, and 116 arranged in the top-left quadrant of grid 136, This may be a default layout for the sensors in secure area 110. Further, data streams from cameras 122, 124, and 126 are represented on the right half of grid 136. This configuration may be default, or arranged by the operator. For instance, the operator may drag and drop additional data streams from the list 138 into the grid 136 and the video feed for the data stream would show up in the respective window. This provides flexibility in dragging and dropping icons to represent data streams in various configurations.

The operator may also group the data streams based on the attributes within the metadata of the data stream. For instance, an operator may choose to display all data streams from only motion-sensing cameras within one window of grid 136. The operator may save this display layout in database 133. Default display layouts or monitor walls may also be stored in database 133. Administrator-defined display layouts may be remotely provisioned into database 133 for access by the local operator. The operator further has the ability to focus on and expand one or more data streams within a display layout, and represent these alongside other data streams from separate display layouts, all within one portion of the grid 136.

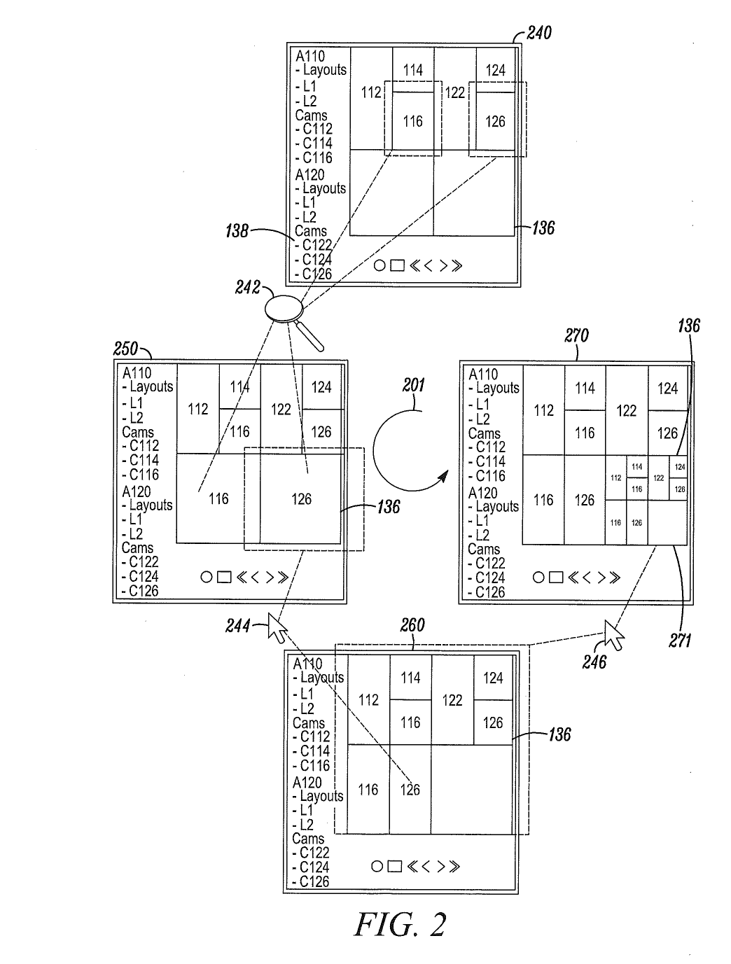

The recursive functionality, according to the present embodiment, is described in FIG. 2. Arrow 201 shows a sequence of operations, starting with screenshot 240. Screenshot 240 shows an identical representation as in FIG. 1. On the left side are provided source selections 138, and the selected data streams are represented in grid 136. Cameras 112, 114, and 116 from secure area 110 are displayed with a layout in the top left quadrant of grid 136. Cameras 122, 124, and 126 from secure area 120 are displayed with a layout in the top right quadrant. The layouts may be default layouts pre-programmed into the system by an operator or an administrator.

A zoom operation 242 is initiated by the operator, to expand data streams 116 and 126. A simple point-and-click operation would allow the operator to represent data stream 116 in the bottom left quadrant, and data stream 126 in the bottom right. This is shown in screenshot 250. It should be noted that the lower two quadrants may themselves be saved as layouts, with each layout comprising one data stream. Alternatively, all four quadrants together may comprise one layout, with the ability to store the layout and recall it for later use. Thus, it should be noted that although four sections are shown in grid 136, the present invention encompasses more varied configurations.

The operator may want to free up one of the quadrants for some reason, for instance to display an additional data stream. Drag-n-drop operation 244 allows the operator to move data stream 126 over to the left, alongside data stream 116. Screenshot 260 shows the result. The two data streams are automatically resized to fit the lower left quadrant, leaving the lower right quadrant free for additional display layouts.

To emphasize the recursive aspect of these operations, a method for saving existing display layouts is also provided. For instance, operation 246 leading to screenshot 270 show what would happen if the grid 136 in screenshot 260 were to be saved as its own layout. Screenshot 270 shows the existing layout as in screenshot 260, with the addition of the entire layout of screenshot 260 condensed into the lower right quadrant. Zooming out and saving the layout of screenshot 260 and loading it separately allows for infinite combinations and display layouts. Multiple data streams are represented piecewise based on operator preferences, or based on their attributes. For instance, in step 242, the operator may have elected to zoom into all motion-sensing devices. Cameras 116 and 126 may be motion sensing devices, thus screenshot 250 shows them represented in separate quadrants. Alternatively the operator may drag and drop motion sensing devices into one section of grid 136, from the selection list 138.

The operator further has the ability to control the features of the remote security monitors and security sensors, said ability to control being provided by commands 139 in GUI 135. For example, a camera may be mounted such it can change its field of view by zooming in or pivoting, via a motor control. Other commands may include focusing, open/close iris, washout, wipe, etc. In this case, such movements can be controlled remotely using an appropriate control and communication scheme, provided via GUI 135. Pan, Tilt, Zoom (PTZ) features also may be performed without physically affecting the camera, hence the term Digital PTZ. It is also possible to change the frame rate and resolution at which the camera provides still frames, or switching from a still frame mode to a motion picture mode, or switching from a visible light mode to an infrared light mode, and so forth. These are adjustable parameters of the camera. Thus, control of security systems in a plurality of remote locations is provided by the monitoring station.

While preferred embodiments of the present invention have been described using specific terms, such description is for illustrative purposes only, and it is to be understood that changes and variations may be made without departing from the spirit or scope of the following claims.

1-20. (canceled)

21. A method comprising:
a monitoring station receiving a plurality of data streams from a plurality of cameras monitoring one or more secured areas, each of the plurality of data streams including metadata appended thereto, the metadata appended to each of the plurality of data streams identifying one or more attributes related to a respective data stream; and
a graphical user interface of the monitoring station displaying visual representations of one or more of the plurality of data streams based on a default display layout associated with each of the plurality of data streams and received user input identifying a user-defined display layout for the one or more of the plurality of data streams,
wherein the user input includes an identification of at least one user-selected attribute and responsive thereto, a logic unit of the monitoring station identifies at least one of the plurality of data streams that includes metadata identifying the at least one user-selected attribute for displaying on the graphical user interface.

22. The method of claim 21 wherein the one or more attributes in the metadata includes at least one of a data stream configuration setting, a type of data stream, connection details, user preferences on video display settings, layouts, and display modes, access, privilege and permission details, rules and actions, date and time of recording, or associated events and alarms.

23. The method of claim 21 wherein the metadata is appended to each of the plurality of data streams in a header thereof.

24. The method of claim 23 further comprising the logic unit of the monitoring station parsing the metadata in the header of each of the plurality of data streams.

25. The method of claim 21 further comprising retrieving the default display layout from a database device.

26. The method of claim 21 further comprising retrieving the default display layout from the metadata appended to a respective data stream.

27. The method of claim 21 wherein the user input includes an identification of at least one of the plurality of data streams or at least one of the plurality of cameras.

28. The method of claim 21 further comprising storing the user-defined display layout in a database device.

29. The method of claim 28 further comprising:
retrieving the user-defined layout from the database device; and
the graphical user interface of the monitoring station displaying the visual representations of the one or more of the plurality of data streams based on the retrieved user-defined layout.

30. The method of claim 21 further comprising storing a configuration of the visual representations of the one or more of the plurality of data streams displayed on the graphical user interface of the monitoring station in a database device.

31. The method of claim 30 further comprising:
retrieving the configuration from the database device; and
the graphical user interface of the monitoring station displaying the visual representations of the one or more of the plurality of data streams based on the retrieved configuration.

32. An apparatus comprising:
a logic unit;
a transceiver coupled to the logic unit; and
a graphical user interface coupled to the logic unit,
wherein the transceiver receives a plurality of data streams from a plurality of cameras monitoring one or more secured areas, each of the plurality of data streams including metadata appended thereto, the metadata appended to each of the plurality of data streams identifying one or more attributes related to a respective data stream,
wherein the graphical user interface receives one or more of the plurality of data streams from the transceiver and displays visual representations of the one or more of the plurality of data streams based on a default display layout associated with each of the plurality of data streams and received user input identifying a user-defined display layout for the one or more of the plurality of data streams, and
wherein the user input includes an identification of at least one user-selected attribute and responsive thereto, the logic unit of the monitoring station identifies at least one of the plurality of data streams that includes metadata identifying the at least one user-selected attribute for displaying on the graphical user interface.

33. The apparatus of claim 32 wherein the one or more attributes in the metadata includes at least one of a data stream configuration setting, a type of data stream, connection details, user preferences on video display settings, layouts, and display modes, access, privilege and permission details, rules and actions, date and time of recording, or associated events and alarms.

34. The apparatus of claim 32 wherein the metadata is appended to each of the plurality of data streams in a header thereof.

35. The apparatus of claim 34 wherein the logic unit parses the metadata in the header of each of the plurality of data streams.

36. The apparatus of claim 32 further comprising:
a database device,
wherein the logic unit retrieves the default display layout from the database device.

37. The apparatus of claim 32 wherein the logic unit retrieves the default display layout from the metadata appended to a respective data stream.

38. The apparatus of claim 32 wherein the user input includes an identification of at least one of the plurality of data streams or at least one of the plurality of cameras.

39. The apparatus of claim 32 further comprising:
a database device,
wherein the logic unit stores the user-defined display layout in a database device,
wherein, responsive to second user input, the logic unit retrieves the user-defined layout from the database device, and
wherein the graphical user interface receives the retrieved user-defined layout from the logic unit and displays the visual representations of the one or more of the plurality of data streams based on the retrieved user-defined layout.

40. The apparatus of claim 32 further comprising:
a display device,
wherein the logic unit stores a configuration of the visual representations of the one or more of the plurality of data streams displayed on the graphical user interface of the monitoring station in a database device,
wherein, responsive to second user input, the logic unit retrieves the configuration from the databased device, and
wherein the graphical user interface receives the configuration from the logic unit and displays the visual representations of the one or more of the plurality of data streams based on the retrieved configuration.
